(19) United States
(12) Patent Application Publication
(10) Pub. No.: US 2014/0092206 A1
(43) Pub. Date: Apr. 3, 2014

(54) AIRCRAFT PROVIDED WITH A SYSTEM FOR OBSERVING PART OF THE AIRCRAFT'S ENVIRONMENT

(71) Applicants: Gérard Boucourt, Rouffiactolosan (FR); Xavier Carrier, Rouffiactolosan (FR); Laurent Groux, Mons (FR)

(72) Inventors: Gérard Boucourt, Rouffiactolosan (FR); Xavier Carrier, Rouffiactolosan (FR); Laurent Groux, Mons (FR)

(73) Assignee: LATECOERE, Toulouse (FR)

(21) Appl. No.: 14/009,177

(22) PCT Filed: Apr. 2, 2012
(86) PCT No.: PCT/EP2012/055994

§ 371 Date: Dec. 13, 2013

(30) Foreign Application Priority Data
Apr. 1, 2011 (FR) 1152826

(51) Int. Cl. H04N 5/232

(52) U.S. Cl. CPC H04N 5/23238
USPC 348/36

(57) ABSTRACT

An aircraft (11) includes a system for observing part of the external environment of the aircraft. The environment observation system includes a camera, known as a panoramic camera (21, 22, 23), including a stationary camera associated with a lens that can focus a panoramic field of view simultaneously in both azimuth, about an axis of the panoramic camera, and elevation in a plane containing the axis. The panoramic camera is connected to at least one display screen disposed inside the aircraft (11) and is positioned such that part of the external environment of the aircraft (11) is located in its field of view.

### TECHNICAL FIELD

The present invention relates to an aircraft provided with a system for observing an environment of this aircraft.

### PRIOR ART

In effect, in numerous situations it is necessary to be able to know, at least approximately, the position of an aircraft with respect to its environment, particularly with respect to any obstacles in this environment that might need to be avoided in order not to damage the aircraft, but also to assist with guiding this aircraft within its environment.

For example, it is known practice to place in a lower part of an airplane a camera which is sited in such a way as to observe a landing gear of this airplane. The successive images captured by the camera are transmitted to the flight deck and displayed on a display screen. Thus, when the airplane is on the ground and moving around, the flight crew can see the position of the landing gear relative to the ground markings provided to assist the flight crew in guiding the airplane along the ground.

Furthermore, the images provided by this camera may also make it possible to detect any obstacles on the ground and thus allow these obstacles to be avoided.

In certain airplanes, the images captured by this camera are also transmitted to the entertainment system and displayed on screens intended for the passengers, who can then see the airplane environment, including in flight.

### SUMMARY OF THE INVENTION

The present invention seeks to propose an improved system for observing an environment of an aircraft, that allows a better appreciation of the position of aircraft in relation to its environment.

To this end, the present invention proposes an aircraft comprising a system for observing an environment of this aircraft, comprising at least one camera having a panoramic field of view, referred to as a “panoramic camera”, said panoramic camera being connected to at least one display screen situated inside the aircraft. Further, the panoramic camera is sited in such a way that part of the aircraft environment is in its field of view.

In preferred embodiments, the field of view of the panoramic camera is panoramic both in azimuth, about an axis of the panoramic camera, and in elevation in a plane containing said axis of the panoramic camera, and said panoramic camera is of the type comprising a fixed camera associated with an objective lens capable of focusing all of the panoramic field of view simultaneously onto said fixed camera.

Throughout the present description, a panoramic camera is intended to mean a camera that has a field of view with an angular width in excess of 150 degrees. In preferred embodiments, the panoramic camera advantageously has a very wide field of view, with an angular width in excess of 240 degrees, for example in azimuth.

In the case of a field of view that is panoramic both in azimuth and in elevation, the angular width of said field of view is greater than 150 degrees both in elevation and in azimuth. A field of view as wide as this advantageously allows very wide areas of the aircraft environment to be observed. For example, in the case of such a panoramic camera sited in a low part of the aircraft and observing one or more landing gear(s), it will be possible not only to detect obstacles arriving from the side in relation to the landing gear but also obstacles arriving from underneath. This is particularly advantageous notably for aircraft of the helicopter type.

Because the camera is panoramic, it will make it possible to observe a wider part of this environment. For preference, the panoramic camera may be sited in such a way as to observe both an external portion of the aircraft (fuselage, tail, wing structure, landing gear, engine, etc.) and also an environment around this external portion, more extensive than with systems according to the prior art. Thus, the presence of any potential obstacles there might be may be detected more quickly, via the display screen. This represents a significant advantage for example for aircraft with a high level of inertia, such as airplanes, in the case of which obstacles need to be detected very early on so that they can be avoided.

Because the panoramic camera consists of a fixed camera associated with an objective lens capable of focusing all of the panoramic field of view simultaneously onto said fixed camera, all of the panoramic field of view can be captured simultaneously and each image captured represents all of the panoramic field of view.

According to one particularly preferred embodiment of the invention, the panoramic camera is sited so that at least part of a wing structure of the aircraft is in its field of view. This is advantageous because the wing structure of an aircraft, which may be fixed or rotary depending on the type of aircraft, is generally highly exposed to impacts, particularly on the ground or near the ground, because it is generally made up of protruding elements (wings, blades, etc.).

In preferred embodiments of the invention, with the aircraft being of the airplane type and the wing structure comprising two fixed lateral wings, the panoramic camera has a field of view that is wide enough to observe a distal end of each of the wings of the wing structure of the aircraft. Thus, a pilot of the aircraft can simultaneously observe the wing tips of both wings on one and the same display screen, and can do so in real time. Further, all the aircraft parts that lie between these wing tips, including the wings of the aircraft, will be visible on the display screen, so that the pilot will be able to make a visual check of the integrity of the wings.

In one particularly preferred embodiment, the panoramic camera is sited in a vertical stabilizer of the aircraft. This is because such a siting allows a good view of the wing structure of the aircraft, particularly in the case of an airplane, because the vertical stabilizer allows the panoramic camera to be sited in a part that is raised up above the wing structure.

According to a particularly preferred embodiment of the invention, which can be considered alone or in combination with one of the previous embodiments, the observation system comprises a panoramic camera sited in such a way that at least part of a landing gear of the aircraft is in its field of view. Because the camera is panoramic, it can be sited in such a way as to observe an environment around this landing gear that is more extensive than can be achieved with systems according to the prior art. Thus, the presence of any obstacles there might be can be detected sooner.

In one particular embodiment, the observation system comprises a panoramic camera sited in such a way that and having a field of view that is sufficiently wide that a forward and a rear landing gear of the aircraft are in said field of view.

According to one particularly preferred embodiment of the invention which can be considered alone or in combination with one of the previous embodiments, the observation system comprises a panoramic camera sited in such a way that part of the rear environment of the aircraft, on the opposite side to a flight deck of the aircraft, is in its field of view. Such a position makes it possible to have a wide view of what is situated behind the aircraft, something which is particularly advantageous for example in the case of aircraft able to run backwards, in order to be able to see how clear the runway is etc.

In particular embodiments, at least one panoramic camera has a field of view in azimuth with an angular width of 360 degrees about an axis of the camera. For example, in the case of such a panoramic camera sited in a low part of an airplane and observing one or more landing gear(s), it will be possible also, using this panoramic camera, to observe the engines mounted under the wings of the airplane.

In particular embodiments, at least one panoramic camera is a camera that is sensitive in the infrared wavelengths. A camera of this type advantageously allows image processing to be carried out, notably to detect fire or smoke, and thus protect the passengers or their luggage, or even certain elements of the aircraft. The camera may also act as a thermographic sensor, detecting a hotspot by inserting pictures onto the displayed stream of images, and thus detect the presence of smoke or persons.

### INTRODUCTION TO THE FIGURES

The invention will be better understood from reading the following description and from studying the accompanying figures. These figures are given by way of entirely nonlimiting illustration of the invention and depict:

FIG. 1. a schematic depiction of an aircraft of the airplane type, viewed from above, according to a preferred embodiment; and

FIG. 2. a schematic depiction of an aircraft of the airplane type, viewed from the side, according to an alternative form of embodiment of the invention.

Elements that are identical, similar or analogous retain the same references from one figure to another.

### DETAILED DESCRIPTION OF SOME EMBODIMENTS

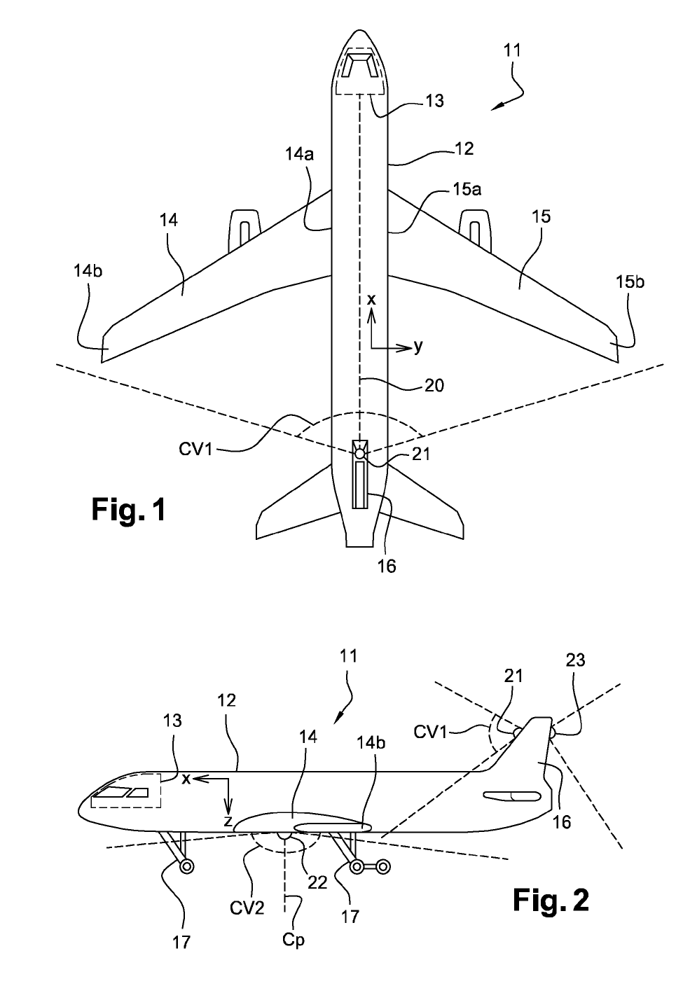

FIG. 1 illustrates a preferred embodiment of the invention and depicts an aircraft 11 of the airplane type, viewed from above.

For the purposes of the description, a frame of reference comprising three axes x, y, z is associated with the aircraft 11. The axis x is a longitudinal axis of the aircraft 11. The axis y is an axis orthogonal to the axis x, making with the axis x a plane that is substantially parallel to a floor of the aircraft 11. The axis z is orthogonal to the axis x and to the axis y and is therefore substantially orthogonal to the floor of the aircraft 11.

The aircraft 11 comprises a fuselage 12 extending substantially longitudinally along the axis x. The aircraft 11 in a forward zone comprises a flight deck in which the flight crew may be accommodated. The aircraft 11 also comprises a fixed wing structure made up chiefly of two lateral wings 14, 15. The lateral wing 14 comprises a root 14a at the fuselage 12 end and a distal end 14b at the opposite end to said root 14a. The lateral wing 15 comprises a root 15a at the fuselage 12 end and a distal end 15b at the opposite end to said root 15a.

The aircraft 11 also comprises a vertical stabilizer 16, secured to the fuselage 12 in a rear zone of the aircraft 11 and projecting more or less along the axis z associated with the aircraft 11.

The aircraft also comprises a system for observing an external environment of this aircraft, fitted with a camera 21.

In the nonlimiting example illustrated in FIG. 1, the camera 21 is sited in the vertical stabilizer 16 and aimed toward the front of the aircraft 11, i.e. toward the flight deck 13. The camera 21 is connected by a communications link 20 to a display screen, not depicted in the figures, able to broadcast the images acquired by the camera 21. The communications link 20 may be a wired or radio communications link.

In the example given in FIG. 1, the display screen is in the flight deck 13 so as to display the images to the flight crew. There is nothing to prevent the display screen from being situated, in other examples, elsewhere in the aircraft 11 than in the flight deck, in order to display images intended for the passengers or the cabin crew. In particular, when the observation system comprises several display screens, these may be situated at different locations in the aircraft.

The camera 21 of the observation system is a camera with a wide field of view referred to as a “panoramic camera”.

What is meant by panoramic camera is a camera that has a field of view of an angular width in excess of 150 degrees, preferably in excess of 240 degrees.

According to the invention, the panoramic camera 21 is sited in such a way that part of the environment of the aircraft 11 is in its field of view. For preference, the panoramic camera 21 is sited in such a way as to observe both an external portion of the aircraft and an environment around this external portion.

In the example of FIG. 1, the field of view CV1 of the panoramic camera 21 is approximately of an angular width of 160 degrees in the plane of the figure, and is bounded by broken lines.

Such an angular width makes it possible, in the example depicted, to have all of the lateral wings 14 and 15, including the distal ends 14b and 15b thereof in the field of view of the panoramic camera 21.

The panoramic camera 21 could be a camera capable of rotating about a fixed axis, or could even comprise a fixed (stationary) camera associated with a mirror system that was able to rotate. In such instances, the full panoramic field of view can be observed by moving the mobile camera and/or the mobile mirror system and by capturing successive images each representing part of the panoramic field of view.

For preference, the panoramic camera 21 comprises a fixed camera associated with a fixed objective lens that allows all of the panoramic field of view to be focused simultaneously and comprising diffractive, refractive optical elements involving concave and/or convex mirrors, half-silvered mirrors, etc. In such instances, it is possible to capture the entire panoramic field of view of the panoramic camera 21 simultaneously, and each image captured represents all of the panoramic field of view. By way of example, in the context of the present invention it is possible to make use of a camera like the one described in Patent Application FR-A-2 902 592. Thus, all the elements that make up the panoramic camera 21 are preferably immobile, and said panoramic camera 21 does not need to comprise mechanical and electrical means for driving the camera or its objective lens, which drive means are often bulky and require regular maintenance.

Siting the panoramic camera 21 in the vertical stabilizer 16 represents an advantage because it allows the panoramic camera 21 to be sited in a raised part of the aircraft 11. In that way, the flight crew has an overall view of the aircraft 11. Further, the flight crew has a view, on one and the same display screen, of not only the tips of the wings 14 and 15 but also the top surface (or suction face surface) of said wings. Thus, the flight crew can make a visual inspection of the integrity of the wings.

FIG. 2 depicts an alternative form of embodiment of the aircraft 11 of FIG. 1. The aircraft 11 comprises landing gears 17, two of which can be seen in FIG. 2: a forward landing gear 17 on the same side as the flight deck 13 and a rear landing gear 17 under the wing structure 14, 15.

The engines, which are visible in FIG. 1, have not been depicted in FIG. 2 in order to make that figure easier to understand.

In the alternative form of embodiment illustrated in FIG. 2, the observation system comprises, in addition to the panoramic camera 21 sited in the vertical stabilizer 16, a second panoramic camera 22 sited under the aircraft 11.

The second panoramic camera 22 is sited in such a way that at least part of a landing gear 17 of the aircraft 11 is in its field of view. For preference, the second panoramic camera 22 is of the type comprising a fixed camera associated with a fixed objective lens that allows all of the panoramic field of view to be focused.

In the nonlimiting example illustrated in FIG. 2, said second panoramic camera 22 is sited between the forward and rear landing gears 17 and said landing gears 17 of the aircraft 11 are in the field of view of said second panoramic camera (the field of view of the second panoramic camera 22 in the plane of the figure being bounded by discontinuous lines and denoted CV2). There is nothing to prevent considering other positions for the second panoramic camera 22, in other embodiments not illustrated in the figures, in which camera positions the forward and rear landing gears 17 of the aircraft 11 are in the field of view of said second panoramic camera. For example, the second panoramic camera 22 may be sited in the forward zone of the aircraft 11, in front of the front and rear landing gears 17, under the flight deck 13. In that way, it is possible, using one and the same camera, to observe the front and rear landing gears 17 while at the same time having a clear view toward the front of the aircraft 11. In another nonlimiting example, the second panoramic camera 22 may be sited in the rear zone of the aircraft 11, behind said front and rear landing gears 17, under the vertical stabilizer 16. In that way, it is possible using one and the same camera to observe the front and rear landing gears 17 while having a clear views toward the rear of the aircraft 11. In another nonlimiting example, the second panoramic camera 22 may be sited under either one of the lateral wings 14, 15. In that way it is possible, with one and the same camera, to observe the forward and rear landing gears 17 while having a clear view toward the front and toward the rear of the aircraft 11.

Furthermore, in the nonlimiting example of FIG. 2, the observation system also comprises a third panoramic camera 23, likewise sited in the vertical stabilizer 16, but at the rear thereof, and facing toward the rear of the aircraft, i.e. away from the flight deck. For preference, the third panoramic camera 23 is of the type comprising a fixed camera associated with a fixed objective lens capable of focusing the entire panoramic field of view.

The third panoramic camera 23 does not observe any external portion of the aircraft but provides a better overview of the environment of the aircraft 11 by supplying a view of the environment located behind said aircraft.

For preference, at least one panoramic camera of the observation system makes it possible to obtain a panoramic field of view not only about an axis of said camera (in azimuth) but also in relation to the camera axis in a plane containing said camera axis (in elevation). Specifically, such a panoramic camera makes it possible to look in numerous directions in azimuth and in elevation. For example, if a panoramic camera has a panoramic field with an angular width of more or less 360 degrees in azimuth, and more or less 180 degrees in elevation, such a panoramic camera will make it possible to observe a solid angle of around 2Π steradians, namely a field of view that is more or less hemispherical. The panoramic camera example given in Patent Application FR-A-2 902 592 makes it possible to have a field of view with an angular width or more or less 360 degrees in azimuth and almost 150 degrees in elevation.

By way of nonlimiting example, an axis of the second panoramic camera 22 has been denoted Cp. If the field of view of the second panoramic camera 22 is wide enough in azimuth about the axis Cp, particularly if it has an angular width of more or less 360 degrees, such a position of the second panoramic camera 22 allows it to observe all the landing gears 17 of the aircraft 11, a forward environment of the aircraft 11 and a rear environment of the aircraft 11 and also the engines mounted under the wings (but not depicted in FIG. 2).

If the second panoramic camera 22 also has a panoramic field of view in elevation with respect to the axis Cp, such a siting of the second panoramic camera 22 allows it likewise to look toward the underside of the aircraft 11.

This environment observation system according to the invention allows a significant improvement in the visibility offered to the flight crew regarding the environment in which the aircraft is situated. Further, because of the use of panoramic cameras, the need for cameras is reduced, because several external portions of the aircraft 11 could be observed using one and the same panoramic camera and one and the same display screen. This objective is achieved not only by means of panoramic cameras but also by suitable siting of these panoramic cameras.

In addition, the entirety of the field of view of a panoramic camera may advantageously be presented to the flight crew in the form of a single image. In that way, the flight crew has instant access to information relating to several portions of the aircraft 11, such as the wings 14, 15 (including their distal ends or wing tips 14b, 15b), the landing gears 17, the engines, an environment in front of and/or behind the aircraft 11, etc.

The surveillance system for example comprises at least one panoramic camera that is sensitive in a band of visible wavelengths (i.e. wavelengths of between 0.4 micrometers and 0.7 micrometers) and/or in a band of infrared wavelengths (i.e. wavelengths of between 0.7 micrometers to 100 micrometers). In the case of a panoramic camera that is sensitive in an infrared waveband, said panoramic camera is preferably sensitive in one of the following wavebands:
0.7 to 3 micrometers (band I)
3 to 5 micrometers (band II)
8 to 14 micrometers (band III).

When the surveillance system comprises several panoramic cameras, these are sensitive in one and the same waveband or in different wavebands.

For preference, at least one panoramic camera offers low distortion, making it possible to obtain a view similar to human eyesight while at the same time having a panoramic field of view. Thus, it will be easier for the flight crew to interpret the images.

More generally, it will be understood that the invention, described with reference to FIGS. 1 and 2 in the case of an aircraft 11 of the airplane type, is also applicable to other types of aircraft the environment of which needs to be observed and displayed to individuals inside the aircraft.

In particular, the invention also finds an advantageous application in the case of an aircraft of the helicopter type. Specifically, in helicopters, the use of an observation system according to the invention may make it possible greatly to reduce the risk of accidents, including in-flight accidents.

According to the invention, a helicopter then comprises an observation system comprising a panoramic camera, for example:
one panoramic camera in a high-up part of the helicopter, with all or part of the rotary wing structure in its field of view, and/or
one panoramic camera in a low-down part with all or part of a landing gear of the helicopter and the underside of the helicopter in its field of view.

More generally, it will be appreciated that such a system for observing the environment of an aircraft according to the invention comprises at least one panoramic camera and that said at least one panoramic camera can be sited at any one of the positions described with reference to FIGS. 1 and 2 or at any other position that allows an external environment of an aircraft to be observed. A system for observing the environment of an airplane according to the invention may comprise a single panoramic camera, for example sited in the vertical stabilizer or under the aircraft, or a combination of panoramic cameras sited at different points.

The system for observing the environment of an aircraft has numerous possible applications. It may, for example, be used for the surveillance of the aircraft environment (for checking the integrity of the wings, the integrity of the engine, for checking that the landing gear is down, etc.) in flight or on the ground (runway, taxiway, parking area, etc.) to assist with guiding the aircraft (avoid collision with obstacles, notably by observing the wing tips and/or by observing an environment behind the aircraft when it is rolling backwards, checking the orientation of the aircraft in relation to the runway, estimating the position of the aircraft by identifying markers in the field of view, etc.), etc.

1. An aircraft (11) comprising a system for observing an external environment of said aircraft, characterized in that the environment observation system comprises a camera, referred to as “panoramic camera” (21, 22, 23), comprising a fixed camera associated with an objective lens able to focus a field of view which is panoramic both in azimuth, about an axis of the panoramic camera, and in elevation in a plane containing said axis of the panoramic camera, said panoramic camera being connected to at least one display screen situated inside the aircraft and being sited in such a way that part of the external environment of the aircraft (11) is in its field of view.

2. The aircraft (11) as claimed in claim 1, characterized in that the panoramic camera (21) is sited in such a way that at least part of a wing structure (14, 15) of the aircraft (11) is in its field of view.

3. The aircraft (11) as claimed in claim 2, characterized in that, with the aircraft being of the airplane type, the panoramic camera (21) has a field of view that is wide enough to observe a distal end (14b, 15b) of each of the wings (14, 15) of the wing structure of the aircraft (11).

4. The aircraft (11) as claimed in claim 2, characterized in that the panoramic camera (21) is sited in a vertical stabilizer (16) of the aircraft (11).

5. The aircraft (11) as claimed in claim 1, characterized in that the panoramic camera (22) is sited in such a way that at least part of a landing gear (17) of the aircraft (11) is in its field of view.

6. The aircraft (11) as claimed in claim 5, characterized in that the panoramic camera (22) is sited in such a way that a forward landing gear (17) and a rear landing gear (17) of the aircraft (11) are in its field of view.

7. The aircraft (11) as claimed in claim 1, characterized in that the panoramic camera (23) is positioned in such a way that part of the rear environment of the aircraft (11) on the opposite side to a flight deck (13) of the aircraft (11), is in its field of view.

8. The aircraft (11) as claimed in claim 1, characterized in that the panoramic camera (21, 22, 23) has a field of view in azimuth of an angular width of 360 degrees.

9. The aircraft (11) as claimed in claim 1, characterized in that the panoramic camera (21, 22, 23) is a camera that is sensitive in the infrared wavelengths.

10. The aircraft (11) as claimed in claim 3, characterized in that the panoramic camera (21) is sited in a vertical stabilizer (16) of the aircraft (11).
